(19) United States
(12) Patent Application Publication
(10) Pub. No.: US 2019/0166958 A1
(43) Pub. Date: Jun. 6, 2019

(54) LOCKING OR SELF-CLOSING ZIPPER

(71) Applicant: Rafael RODRIGUEZ, NY, NY (US)

(72) Inventor: Rafael RODRIGUEZ, NY, NY (US)

(21) Appl. No.: 16/323,961

(22) PCT Filed: Jun. 20, 2018
(86) PCT No.: PCT/US18/38630

§ 371 Date: Feb. 7, 2019

Related U.S. Application Data
(60) Provisional application No. 62/488,011, filed on Apr. 20, 2017.

(51) Int. Cl. A44B 19/30; A45C 13/10; A45C 13/24; H04W 4/80; H04W 4/029; G08B 13/14

(52) U.S. Cl. CPC A44B 19/301; A45C 13/103; G08B 13/1427; H04W 4/80; H04W 4/029; A45C 13/24

(57) ABSTRACT

A zipper locking device, where the zipper locking device can include a lock portion and a pull tab portion. The zipper latch mechanism of the pull tab portion may fit into the lock portion, creating a locked zipper. The zipper locking device may be opened via a combination and/or a key. The zipper locking device can include a geo-location feature where the bag on which the zipper locking device is attached may be tracked. The zipper locking device may further include an alarm feature, where, when the zipper locking device is separated from the user by a pre-defined distance, an alarm may alert the user. In some embodiments, the zipper locking device may be self-closing.

### BACKGROUND OF THE INVENTION

The present invention relates to enclosures and, more particularly, to a zipper that may be a self-closing or locking zipper.

Currently, luggage locks are usually added secure two zipper ends together. These locks can include combination locks, keyed locks or other similar designs. These locks, however, pose several issues. First, the locks may get lost, as they may be completely removed from the luggage. Moreover, keys for these locks may get lost, especially during travel, or combinations may be forgotten. Also, the locks dangle off the bags both by the extension of the zipper pull length and the length of the lock itself. This may pose a catch point for the bags to get caught during transport and transfer to and from an aircraft, for example. Should the lock get caught, at best the lock may break, however, such a situation could damage the luggage itself, causing tears and exposing the luggage contents.

As can be seen, there is a need for an improved zipper lock that may be used on bags, such as luggage, backpacks, handbags, and the like.

### BRIEF DESCRIPTION OF THE DRAWINGS

FIG. 1 shows a front view of a zipper-lock mechanism according to an exemplary embodiment of the present invention;

FIG. 2 shows a side view of the zipper-lock mechanism of FIG. 1;

FIG. 3 shows a detailed top view of the zipper-lock mechanism taken about circle III of FIG. 1;

FIG. 4 shows a detailed side view of the zipper-lock mechanism taken along circle IV of FIG. 2;

FIG. 5 shows a perspective view of the zipper-lock mechanism of FIG. 1 in an open state;

FIG. 6 shows a top view of the zipper-lock mechanism of FIG. 1 in an open state;

FIG. 7 shows a side view of the zipper-lock mechanism of FIG. 1 in an open state;

FIG. 8 shows a perspective view of the lock side of the zipper-lock mechanism of FIG. 1;

FIG. 9 shows a top view of the lock side of FIG. 8;

FIG. 10 shows a side view of the lock side of FIG. 8;

FIG. 11 shows a top view of the zipper side of the zipper-lock mechanism of FIG. 1;

FIG. 12 shows a side view of the zipper side of FIG. 11; and

FIG. 13 shows a perspective view of the zipper side of FIG. 11.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to-achieve the desired implementation that addresses the needs of the particular application.

Broadly, an embodiment of the present invention provides a zipper locking device, where the zipper locking device can include a lock portion and a pull tab portion. The zipper latch mechanism of the pull tab portion, also referred to as the zipper crown, may fit into the lock portion, creating a locked zipper. The zipper locking device may be opened via a combination and/or a key, or the like. The zipper locking device can include a geo-location feature where the bag on which the zipper locking device is attached may be tracked. The zipper locking device may further include an alarm feature, where, when the zipper locking device is separated from the user by a pre-defined distance, an alarm may alert the user. In some embodiments, the zipper locking device may be self-closing.

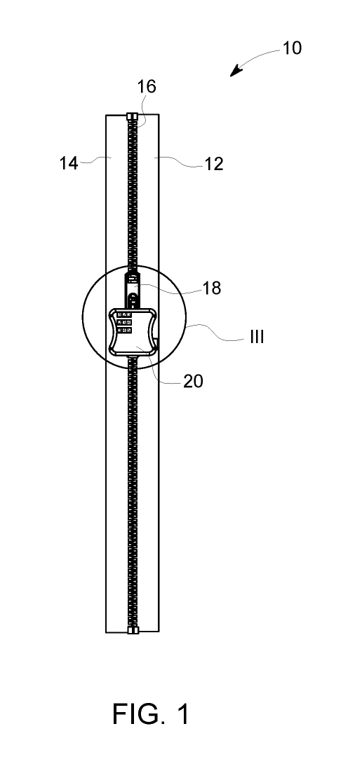

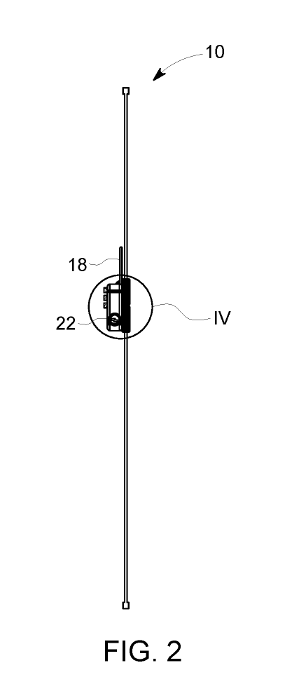

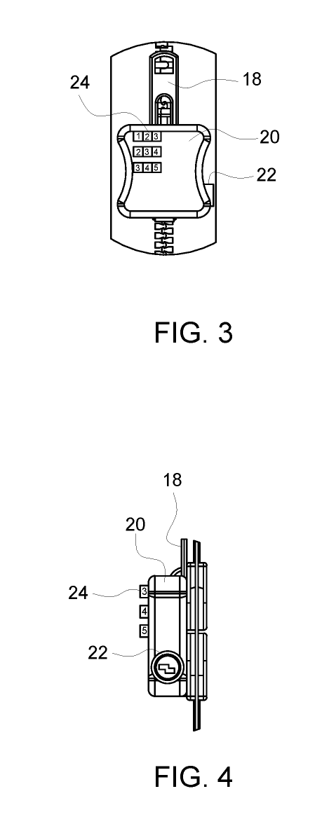

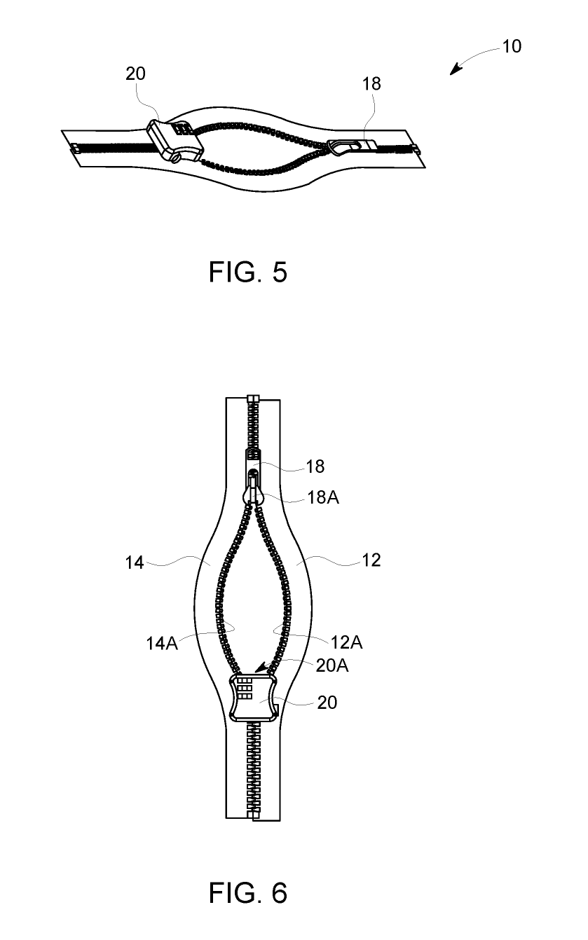

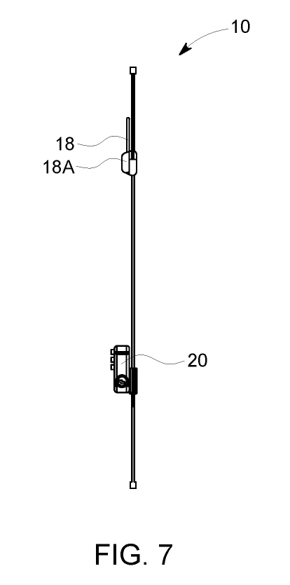

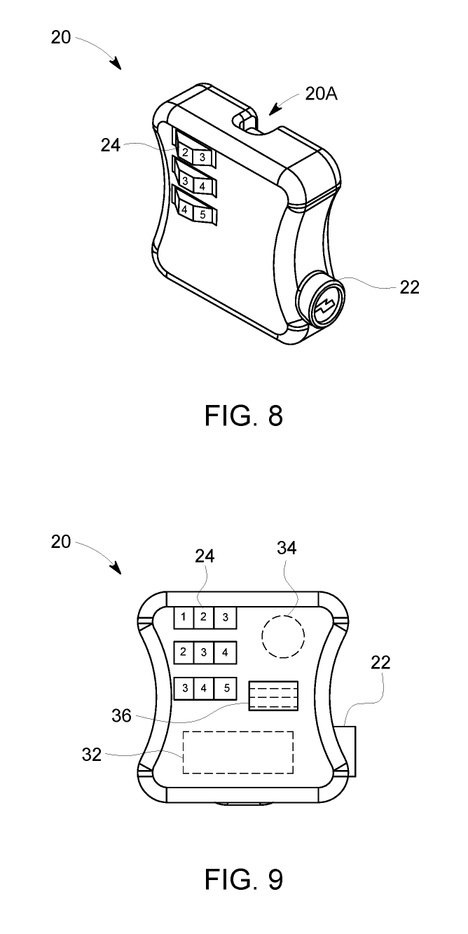

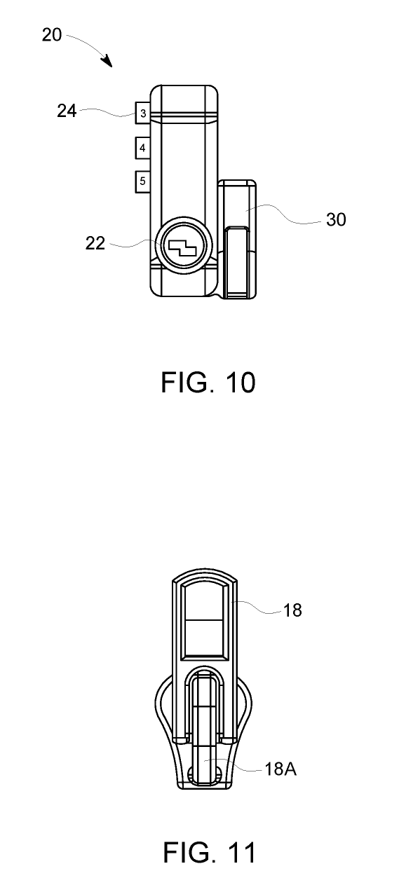

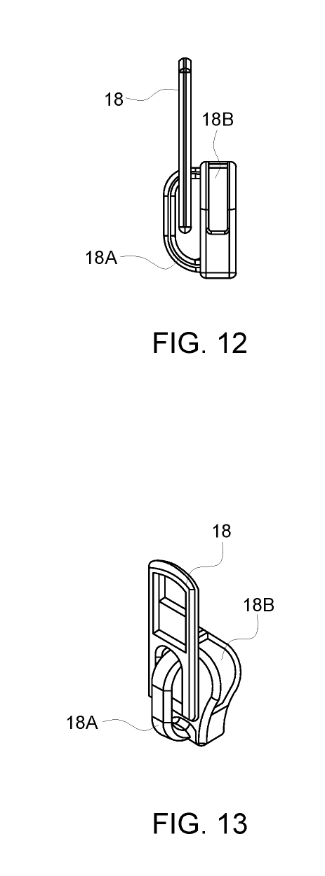

Referring to FIGS. 1 through 13, a zipper closure 10 may be used to connect a first side 12 and a second side 14 of an object, such as a bag, luggage, handbag, purse, backpack or the like. The zipper closure 10 can include zipper teeth 16 that may come together or be separated as a zipper pull 18 or a lock member 20 is moved along the zipper teeth 16 through openings 18B in the zipper pull 18. The mechanism of zipper teeth closure and opening may be similar to those processes known in the art.

In some embodiments, a single zipper closure 10 may be closed by two zipper pulls that meet when the bag is closed. In this embodiment, one of the zipper pulls may be the lock member 20 having an opening 20A, where a crown 18A of the other of the zipper pulls fits into the opening 20A to securely hold the two together. This allows the zipper to lock without having an additional, hanging lock attached to the zipper pulls. The lock can be formed to be opened and closed by various mechanisms. For example, once locked, the lock may be opened by a wireless device, such as a wireless connected mobile phone, a combination lock 24, a keyed lock 22, a biometric scan, such as a fingerprint, or the like. The lock itself may be formed in various types, as may be known in the art. In some embodiment, the zipper pulls may be magnetized to help secure the ends together.

In some embodiments, the lock portion 20 can include a wireless transmitter 34, such as a Bluetooth® transmitter. In this embodiment, the lock portion 20 may be linked to a user's smart phone to provide the user of lock status, geo-location data obtained by a GPS chip 32, or the like. In some embodiments, should the user's smart phone detect that the lock portion 20 is beyond a predetermined distance from the user, the lock portion 20 can include a speaker 36 for sounding an alert. The alert may also be provided to the user's smart phone via the transmitter 34. The lock portion 20 may be powered by a battery (not shown) that may be charged via a port (not shown), as may be known in the art. In some embodiments, a port may be provided on the lock portion 20 to attach a tether to another device, to the user, or the like, so that when the tether is disconnected, the alarm may sound.

In some embodiments, the speaker 36 may also act as a microphone. In other embodiments, a separate microphone may be provided. The microphone may receive voice input for controlling the lock. In some embodiments, the lock may be set with a voice recognition protocol as may be known in the art, to permit the user to voice activate and deactivate the lock.

The lock portion 20 and the zipper pull 18 may be formed during manufacture of the zipper on the bag, luggage, or the like. In some embodiments, the lock portion 20 may be designed to attach to an existing zipper pull in order to retro-fit the system of the present invention onto a conventional bag, without requiring a permanent modification thereof. The retro-fit design may include a receptacle at the bottom of the lock portion 20 for attachment to a zipper, zipper crown, or the like. In some embodiments, the back side of the lock portion 20 may include one or more loops or openings for stitching the lock directly onto a bag so that the zipper crown of an existing zipper may fit therein.

In some embodiments, the zipper may be a self-closing/self-opening zipper, where the zipper can automatically close with the touch of a button, for example. In some embodiments, the zipper may automatically close after a given period of time of inactivity of the bag, or if the bag moves outside a predetermined distance away from a user. In this embodiment, the zipper may self-close and may remain closed until the user sends a signal to the bag to release the zipper. This feature may be both a convenience and a security feature for the bag.

The zipper may have a combination lock that may also be opened with a key, thus making the lock TSA-approved. The zipper-lock may be used on any device that uses a zipper, such as luggage, duffel bags, equipment bags, brief cases, laptop bags, and the like.

In some embodiments, the lock side may be stationary, where the zipper pull side moves toward the lock side. In other embodiments, both the lock side and the zipper pull side may move along the zipper teeth to permit the connection of the zipper pull side with the lock side at any location along the zipper teeth.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species.

The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A zipper lock comprising:
a zipper portion having a zipper pull tab attached to a zipper crown;
a lock portion having an opening for receiving and holding the zipper crown therein; and
a lock release mechanism for releasing the zipper crown from the opening.

2. The zipper lock of claim 1, wherein the lock portion is fixed at one end of the zipper teeth.

3. The zipper lock of claim 1, wherein the lock portion is movable along the zipper teeth.

4. The zipper lock of claim 1, wherein the zipper portion is movable along the zipper teeth to open and close a zipper connection.

5. The zipper lock of claim 1, wherein the lock portion includes at least one of a combination lock and a keyed lock.

6. The zipper lock of claim 5, wherein the lock portion includes both a combination lock and a keyed lock.

7. The zipper lock of claim 1, further comprising a wireless transmitter disposed in the lock portion.

8. The zipper lock of claim 7, wherein the wireless transmitter sends a signal to a wireless device to provide information related to the zipper lock.

9. The zipper lock of claim 8, wherein the information includes a distance between the wireless device and the zipper lock.

10. The zipper lock of claim 9, wherein an alert is provided to a user when the distance between the wireless device and the zipper lock is beyond a predetermined distance.

11. The zipper lock of claim 7, further comprising a geo-location device positioned in the lock portion, the geo-location device providing a location of the zipper lock to a wireless device via the wireless transmitter.

12. The zipper lock of claim 1, wherein the lock portion attaches to an existing zipper pull of a zipper.

13. The zipper lock of claim 1, further comprising a microphone for providing voice control to the lock.

14. The zipper lock of claim 1, further comprising a biometric scanner for receiving a biometric feature of a user for permitting access to control the zipper lock.
